(19) United States
(12) Patent Application Publication
(10) Pub. No.: US 2026/0169019 A1
(43) Pub. Date: Jun. 18, 2026

(54) COLLECTION AND TRANSFER OF FLUID SAMPLES FROM MULTIPLE REMOTE SAMPLE DEVICES TO MULTIPLE ANALYSIS SYSTEMS VIA AN INTERVENING SAMPLE DISTRIBUTION SYSTEM

(71) Applicant: Elemental Scientific, Inc., Omaha, NE (US)

(72) Inventors: Myung Hwan Kim, Omaha, NE (US); Austin Schultz, Omaha, NE (US); David Diaz, Bennington, NE (US); Jonathan Hein, Omaha, NE (US)

(21) Appl. No.: 19/421,045

(22) Filed: Dec. 16, 2025

Related U.S. Application Data
(60) Provisional application No. 63/735,563, filed on Dec. 18, 2024.

(51) Int. Cl. G01N 35/10

(52) U.S. Cl. CPC G01N 35/1097; G01N 35/1016

(57) ABSTRACT

Systems and methods for collecting, transferring, and distributing fluid samples taken from multiple remote sample devices to multiple analysis systems are described. In an aspect, a system embodiment includes, but is not limited to, a plurality of remote sample devices, each remote sample device configured to draw a sample from a sample source; a distribution system fluidically coupled with each remote sample device of the plurality of remote sample devices via a transfer line; and a plurality of analysis systems fluidically coupled with the distribution system, wherein the distribution system includes a valve system having a plurality of valve clusters each of which is configured to transfer samples having a unique chemical composition to specific analysis systems of the plurality of analysis systems.

### CROSS-REFERENCE TO RELATED APPLICATIONS

The present application claims the benefit of 35 U.S.C. § 119(e) of U.S. Provisional Application Ser. No. 63/735,563, filed Dec. 18, 2024, and titled “COLLECTION AND TRANSFER OF FLUID SAMPLES FROM MULTIPLE REMOTE SAMPLE DEVICES TO MULTIPLE ANALYSIS SYSTEMS VIA AN INTERVENING SAMPLE DISTRIBUTION SYSTEM.” U.S. Provisional Application Ser. No. 63/735,563 is herein incorporated by reference in its entirety.

### BACKGROUND

In many laboratory settings, it is often necessary to analyze a large number of chemical or biological samples at one time. In order to streamline such processes, the manipulation of samples may be mechanized. Such mechanized sampling can be referred to as autosampling and can be performed using an automated sampling device, or autosampler.

Spectrometry refers to the measurement of radiation intensity as a function of wavelength to identify component parts of materials. Inductively Coupled Plasma (ICP) spectrometry is an analysis technique commonly used for the determination of trace element concentrations and isotope ratios in liquid samples. For example, in the semiconductor industry, ICP spectrometry can be used to determine metal concentrations in samples. ICP spectrometry employs electromagnetically generated partially ionized argon plasma that reaches a temperature of approximately 7,000K. When a sample is introduced to the plasma, the high temperature causes sample atoms to become ionized or emit light. Since each chemical element produces a characteristic mass or emission spectrum, measuring the spectra of the emitted mass or light allows the determination of the elemental composition of the original sample. The sample to be analyzed is often provided in a sample mixture.

Sample introduction systems may be employed to introduce the liquid samples into the ICP spectrometry instrumentation (e.g., an Inductively Coupled Plasma Mass Spectrometer (ICP/ICP-MS), an Inductively Coupled Plasma Atomic Emission Spectrometer (ICP-AES), or the like), or other sample detector or analytic instrumentation for analysis. For example, a sample introduction system may withdraw an aliquot of a liquid sample from a container and thereafter transport the aliquot to a nebulizer that converts the aliquot into a polydisperse aerosol suitable for ionization in plasma by the ICP spectrometry instrumentation. The aerosol is then sorted in a spray chamber to remove the larger aerosol particles. Upon leaving the spray chamber, the aerosol is introduced into the plasma by a plasma torch assembly of the ICP-MS or ICP-AES instruments for analysis.

### SUMMARY

Systems and methods for collecting, transferring, and distributing fluid samples taken from multiple remote sample devices to multiple analysis systems are described. In an aspect, a system embodiment includes, but is not limited to, a plurality of remote sample devices, each remote sample device configured to draw a fluid sample from a sample source; a plurality of analysis systems configured to determine a chemical composition of the fluid sample from each remote sample device; a distribution system fluidically coupled with each remote sample device of the plurality of remote sample devices via a dedicated fluid transfer line for each remote sample device of the plurality of remote sample devices and with each analysis system of the plurality of analysis systems via at least one fluid transfer line, the distribution system including a valve system having a plurality of valve clusters changeable between different valve configurations to direct fluid from the plurality of remote sample devices to the plurality of analysis systems, wherein each valve cluster of the plurality of valve clusters is configured to transfer samples having a unique chemical composition, and wherein at least two valve clusters of the plurality of valve clusters are fluidically coupled with the same analysis system of the plurality of analysis systems; and a system controller configured to assign the valve configurations of each valve of a valve cluster to transfer sample through the valve cluster to a specific analysis system.

In an aspect, a system embodiment includes, but is not limited to, a plurality of remote sample devices, each remote sample device configured to draw a fluid sample from a sample source; a plurality of analysis systems configured to determine a chemical composition of the fluid sample from each remote sample device; a distribution system fluidically coupled with each remote sample device of the plurality of remote sample devices via a dedicated fluid transfer line for each remote sample device of the plurality of remote sample devices and with each analysis system of the plurality of analysis systems via at least one fluid transfer line, the distribution system including a valve system having a plurality of valve clusters changeable between different valve configurations to direct fluid from the plurality of remote sample devices to the plurality of analysis systems, wherein each valve cluster of the plurality of valve clusters is configured to transfer samples having a unique chemical composition, wherein the valve system includes a first valve cluster and a second valve cluster, wherein the first valve cluster is configured to transfer chemical samples of a first sample type while excluding passage of chemical samples of a second sample type, wherein the second valve cluster is configured to transfer chemical samples of the second sample type while excluding passage of chemical samples of the first sample type, wherein at least two valve clusters of the plurality of valve clusters are fluidically coupled with the same analysis system of the plurality of analysis systems, and wherein the distribution system further comprises a case configured to support each valve cluster of the plurality of valve clusters; and a system controller configured to assign the valve configurations of each valve of a valve cluster to transfer sample through the valve cluster to a specific analysis system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. In the figures, the use of the same reference numbers in different instances in the description and the figures may indicate similar or identical items.

FIG. 1 is a schematic illustration of a system for collecting, transferring, and distributing fluid samples taken from multiple remote sample devices to multiple analysis systems via an intervening sample distribution system, in accordance with example embodiments of the present disclosure.

FIG. 2 is an isometric illustration of a sample distribution having multiple valve clusters to facilitate receipt of multiple sample chemistry types from multiple remote sample devices for coordinated transfer to multiple analysis systems, in accordance with example embodiments of the present disclosure.

FIG. 3 is a schematic illustration of the system of FIG. 1, shown with the intervening sample distribution system having independent valve clusters for specific sample chemistry identities for fluid samples taken from multiple remote sample devices for coordinated transfer to specific analysis systems, in accordance with example embodiments of the present disclosure.

FIG. 4A is a schematic illustration of a valve of the valve cluster of the sample distribution system of FIG. 1 shown in a first valve configuration, in accordance with example embodiments of the present disclosure.

FIG. 4B is a schematic illustration of the valve of FIG. 4A, shown in a second valve configuration.

FIG. 5 is a flow path diagram of a valve cluster of the system of FIG. 1, in accordance with example embodiments of the present disclosure.

FIG. 6A is a flow path diagram of the valve cluster of FIG. 5, shown in a first flow path configuration to direct a sample from a first remote sample device through a first valve to a first analysis system.

FIG. 6B is a flow path diagram of the valve cluster of FIG. 5, shown in a second flow path configuration to direct a sample from the first remote sample device through each of the first valve, a second valve, and a third valve to a third analysis system.

FIG. 7 is a schematic illustration of the valve system of FIG. 1, shown with a valve cluster supporting up to fifteen samples received from fifteen remote sample devices, in accordance with example embodiments of the present disclosure.

FIG. 8 is a schematic illustration of the system of FIG. 1, shown with the control system coordinating transfer of samples to the analysis systems according to a status of each analysis system, in accordance with example embodiments of the present disclosure.

FIG. 9 is a schematic illustration of a flow path for an analysis system configured to receive fluid sample from up to eight transfer lines from the distribution system of FIG. 1, with the analysis system including a sample loop to hold a sample until a desired transfer time to a nebulizer of the analysis system for analytical determination of analyte concentration in the fluid sample, in accordance with example embodiments of the present disclosure.

FIG. 10 is a schematic illustration of a flow path for an analysis system configured to receive fluid sample from up to eight transfer lines from the distribution system of FIG. 1, with the analysis system including two sample loops and two pump systems to hold a sample and prepare the sample for analysis until a desired transfer time to separate spray chambers coupled with an aerosol switching valve in fluid communication with an analysis device for analytical determination of analyte concentration in the fluid sample, in accordance with example embodiments of the present disclosure.

### DETAILED DESCRIPTION

### Overview

Determination of trace elemental concentrations or amounts in a sample can provide an indication of purity of the sample, or an acceptability of the sample for use as a reagent, reactive component, or the like. For instance, in certain production or manufacturing processes (e.g., mining, metallurgy, semiconductor fabrication, pharmaceutical processing, etc.), the tolerances for impurities can be very strict, for example, on the order of fractions of parts per billion. For semiconductor wafer processing, the wafer is tested for impurities, such as metallic impurities, organic impurities or residues, or the like, that can degrade the capabilities of the wafer or render the wafer inoperable. For instance, metallic impurities on the wafer can diminish carrier lifetimes, cause dielectric breakdown of wafer components, and the like, whereas organic impurities can slow silicon dioxide growth, cause unintentional doping, neutralize photo-generated acids, degrade gate-oxide constructs, alter hydrophobicity or hydrophilicity, and the like.

For many fabrication facilities, environmental studies, and other chemically-dependent locations, the sources of chemicals can be physically remote from internal or external laboratories used to test the content of the chemicals, such as to ensure that the samples do not contain unacceptable levels of contaminants or impurities, or, if the samples do contain contaminants or impurities, that a source or cause of the contamination can be determined. However, attempting to manually transfer samples from various sources throughout the fabrication facility can lead to several sample contamination or misidentification risks, health and safety risks, and the like. For instance, many of the samples used in fabrication facilities are hazardous to individuals, where mishandling or accidental exposure to the sample during transit can cause harm to the individual or the environment around the individual. Further, if the sample is misidentified, misplaced, or otherwise erroneously handled, data associated with analysis of the sample may be attributed to an incorrect sample location, an incorrect sample type, or analysis of the sample may take place under conditions unsuitable for the sample (e.g., with an incorrect spray chamber, an incorrect ICP torch, etc.) or that introduce additional errors or impurities to the sample during analysis.

Certain sample handling systems can utilize automated transfer of samples from remote sample devices to a single sample analysis system, such as to process and analyze samples received from many remote sample devices with the single sample analysis system. However, for systems involving many sample sources or that involve throughput of many samples, the single sample analysis system can become overwhelmed by the number of samples, thereby causing many samples to remain idle while the sample analysis system processes the samples. Additionally, for systems involving differing types of samples, the sample analysis system may have downtime between samples, such as to rinse between samples, swap analysis components to accommodate the differing sample types (e.g., different injectors, different spray chambers, different ICP torches, etc.), to condition the system with differing gas flows or temperatures, or the like. Further, the automated systems can include a separate fluid transfer line between each sample source and the analysis system, which can handle relatively large volumes of sample to be purged or sent to waste if the analysis system detects contaminants in the sample in order to verify a contaminant in the sample source or the analysis system.

Still further, systems that include a common valve system for handling all of the sample sources or for handling sample sources having different chemical compositions risk interactions between differing samples within the common valve system, even for systems with rinsing procedures between samples. For instance, for many fabrication facilities, even small amounts of residue of chemicals within the valve system (such as sample residue following rinsing of highly concentrated sample lines) provides an undue risk of manufacturing failure or defect. For example, differing chemical types can react with residue in the common valve system or common transfer lines to precipitate components, to dilute or react with components, or to otherwise jeopardize a chemical analysis by obfuscating the actual concentration of analytes within the original sample. Further, the rinsing procedures can add time to the overall handling of samples for the system, thereby significantly reducing sample throughput.

Accordingly, the present disclosure is directed, at least in part, to systems and methods for collecting, transferring, and distributing fluid samples taken from multiple remote sample devices to multiple analysis systems via an intervening sample distribution system. In aspects, the sample distribution system includes a valve system configured to receive sample from multiple remote sample devices and route individual samples to specified analysis devices. The system can optimize analysis detector utilization by directing samples to analysis systems based upon an analysis status of the various analysis devices. For instance, the system can track the availability of individual analysis devices based on factors including, but not limited to, expected time to process and analyze a sample, time between samples to rinse, type of analysis device. As such, the system can facilitate dynamic scheduling of sample transfer to available analysis systems to reduce sample-to-sample transition time as compared to a system that utilizes a single analysis system to process each sample. The system can also reduce the amount of transfer lines needed to facilitate transfer of samples between the sample sources and the analysis systems by providing internal valve clusters that are fluidically coupled between sample sources having substantially the same chemical composition, thereby reducing the risk of sample contamination through incompatible chemical interaction while also reducing the amounts of overall system samples present in transfer lines.

The system also facilitates redundancy for sample analysis, particularly where a potential contaminant is identified by a particular sample analysis system. The suspected contaminated sample can be routed through the distribution system to another sample analysis system of the same type or a different type as the system that identified the potential contaminant to verify the presence of the contamination. Further, the system can provide redundancy for the analysis systems, such as to permit downtime for maintenance of an analysis system by redirecting samples to another analysis system (e.g., of a same detector type, or by temporarily reconfiguring another analysis system during the maintenance duration).

The valve systems of the present disclosure can maintain separate groupings of valves to process different sample types, such as to maintain separate flow paths for acidic samples, basic samples, organic samples, and the like, and to direct the different sample types to dedicated analysis systems that are specifically configured to handle that sample type, such as by having an appropriate injector type (e.g., injector material, injector size), spray chamber configuration, ICP torch type, material type (e.g., perfluoroalkoxy alkane (PFA), quartz, etc.) to handle the particular sample matrix, and the like. As such, the system can process samples with optimized detector configurations to achieve low detection limits while avoiding transition times to condition the analysis devices between manual changeout of components to accommodate different sample types. In aspects, the system includes multiple spray chambers dedicated to a single analysis system. For example, the system can rinse or otherwise one spray chamber while directing sample through another spray chamber that is available for sample handling (e.g., having undergone a prior rinse or conditioning period while sample flowed through another spray chamber). When analysis is complete, the system can process sample through the rinsed spray chamber while the other spray chamber is then rinsed, providing substantially continuous operation of the analysis system or otherwise minimizing downtime of the analysis system for spray chamber maintenance and management.

### Example Implementations

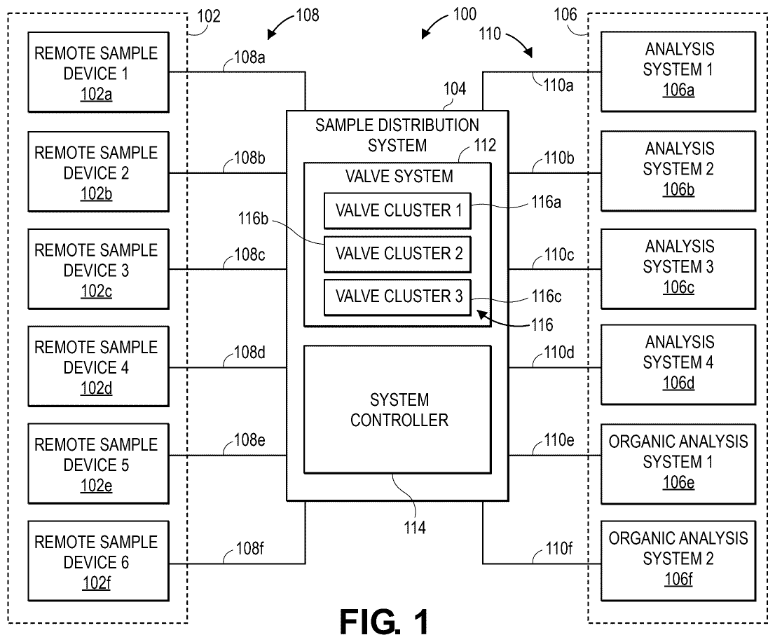

Referring to FIGS. 1 through 10, systems for collecting, transferring, and distributing fluid samples taken from multiple remote sample devices to multiple analysis systems (“system 100”) are shown. The system 100 is shown in FIG. 1 generally including a plurality of remote sample devices 102, a distribution system 104, and a plurality of analysis systems 106. The remote sample devices 102 are fluidically coupled with the distribution system 104 via fluid transfer lines 108 and facilitate drawing fluid samples from different chemical sources or sample locations for transfer to the distribution system 104. For example, the remote sample devices 102 (shown as 102a, 102b, 102c, 102d, 102e, 102f) are shown each having a dedicated fluid transfer line (shown as 108a, 108b, 108c, 108d, 108e, 108f, respectively) coupled with the distribution system 104. In implementations, one or more of the remote sample devices 102 include an autosampler having a probe to draw fluid sample into a sample line for transfer to the distribution system 104, where the transfer can occur via a gas source fluidically coupled with the sample line to direct the sample into and through the transfer line for transport to the distribution system 104. Alternatively or additionally, one or more of the remote sample devices 102 can include a pump to push the sample into and through the transfer line 108 via a working fluid or via additional sample fluid. Alternatively or additionally, one or more of the remote sample devices 102 can couple with a pressurized sample source to introduce the sample into and through the transfer line 108 under pressure. For example, the remote sample devices 102 can be configured as the remote sample systems described in U.S. Pat. No. 11,054,344, which is incorporated herein by reference in its entirety.

The distribution system 104 is fluidically coupled with the analysis systems 106 (shown as 106a, 106b, 106c, 106d, 106e, 106f) via fluid transfer lines 110 (shown as 110a, 110b, 110c, 110d, 110e, 110f, respectively) to coordinate transfer of samples received from the remote sample devices 102 to the analysis systems 106 for determination of analyte composition of the samples. The system 100 generally includes one or more fluid transfer lines 110 for each analysis system 106 coupled between the distribution system 104 and the analysis system 106. For instance, as described further herein, the distribution system 104 can be fluidically coupled with a single analysis system 106 via any number of fluid transfer lines 110 (e.g., a single fluid transfer line, two or more fluid transfer lines), where multiple fluid transfer lines 110 can be utilized to consolidate transfer of samples having different chemical types by maintaining the flow of samples having substantially similar chemical types through dedicated flow passageways.

The analysis systems 106 can include, but are not limited to, mass spectrometers (e.g., Inductively Coupled Plasma Mass Spectrometer (ICP/ICP-MS), Inductively Coupled Plasma Atomic Emission Spectrometer (ICP-AES), Inductively Coupled Optical Emission Spectrometer (ICP-OES), electrospray mass spectrometer, or the like) (e.g., for trace metal or organic determinations), ion chromatograph (e.g., for anion and cation determinations), liquid chromatograph (LC) (e.g., for organic contaminants determinations), Fourier transform infrared spectroscope (FTIR) (e.g., for chemical composition and structural information determinations), particle counter (e.g., for detection of undissolved particles), moisture analyzer (e.g., for detection of water in samples), gas chromatograph (GC) (e.g., for detection of volatile components), or the like. In implementations, the analysis systems 106 are arranged to process samples by sample type such that a first subset of the analysis systems 106 handle a first sample type, a second subset of the analysis systems 106 handle a second sample type, etc., without additional manual manipulation of the analysis system 106 configurations (e.g., to exchange spray chambers, injectors, torches, etc.). For example, the analysis systems 106 can be configured to have four analysis systems 106 configured to process samples for metal analytes for inorganic contaminants (e.g., analysis systems 106a, 106b, 106c, 106d) and with two analysis systems 106 configured to process organic samples for organic contaminants (e.g., analysis systems 106e, 106f). As described further herein, the arrangement of analysis systems 106 by sample type can be specific to a particular chemical type, such as a specific acid and dilutions thereof, a specific inorganic chemical and dilutions thereof, a specific organic chemical and dilutions thereof, and the like.

The system 100 is shown including a valve system 112 to provide specific flow path configurations to transfer samples received from the remote sample devices 102 via the fluid transfer lines 108 to particular analysis systems 106 under control by a system controller 114. The valve system 112 includes individual valve clusters 116 (shown as 116a, 116b, 116c) to provide isolated flow path configurations for specific sample types, such as to avoid samples having different chemical compositions from flowing through the same fluid passages within the distribution system 104, while fluidically coupling with the analysis systems 106 to permit differing samples to be received at the same analysis system 106 or different analysis systems 106. For example, as described further herein, the system controller 114 of the distribution system 104 coordinates transfer of samples received from the remote sample devices 102 by assigning specific flow path configurations of the valve clusters 116 to transfer specific samples to specific analysis systems 106 that are available or soon will be available for sample analysis. The system controller 114 can also coordinate transfer of samples to specific analysis systems 106 that are of an appropriate type to handle that specific sample or sample type or to transfer sample to another analysis system 106 to verify a potential contamination identified by a different analysis system 106, or the like, or combinations thereof. For example, the system controller 114 can coordinate and/or assign which analysis system 106 or which type of analysis system 106 that a particular sample should be sent to, can determine whether that analysis system 106 or type of analysis system 106 is available for analysis, can determine a time at which that analysis system 106 or type of analysis system 106 will be available for analysis, can determine whether a contamination has been detected in a sample by one or more of the analysis systems 106 that exceeds a threshold concentration, which analysis system 106 detected the contamination, whether or when another analysis system 106 of the type of analysis system 106 that detected the contamination is available for a verification analysis, can determine whether any of the analysis systems 106 are currently or scheduled to be in a downtime (e.g., for maintenance or otherwise), or the like, or combinations thereof.

While the system 100 is shown in FIG. 1 generally including six remote sample devices 102, three valve clusters 116, and six analysis systems 106, the system 100 is not limited to such configurations. For instance, the system 100 can facilitate handling of samples from more or fewer than six remote sample devices 102, through more or fewer than three valve clusters 116, and with more or fewer than six analysis systems 106 without departing from the scope of the present disclosure. For example, the amount of valve clusters 116 can be increased to facilitate handling of more than three sample types or decreased to two valve clusters 116 to facilitate handling of two sample types. The amount of analysis systems 106 can vary depending on the amount of samples expected to be processed, where more analysis systems 106 can provide flexibility in maintenance downtime, contaminant verification, and the like.

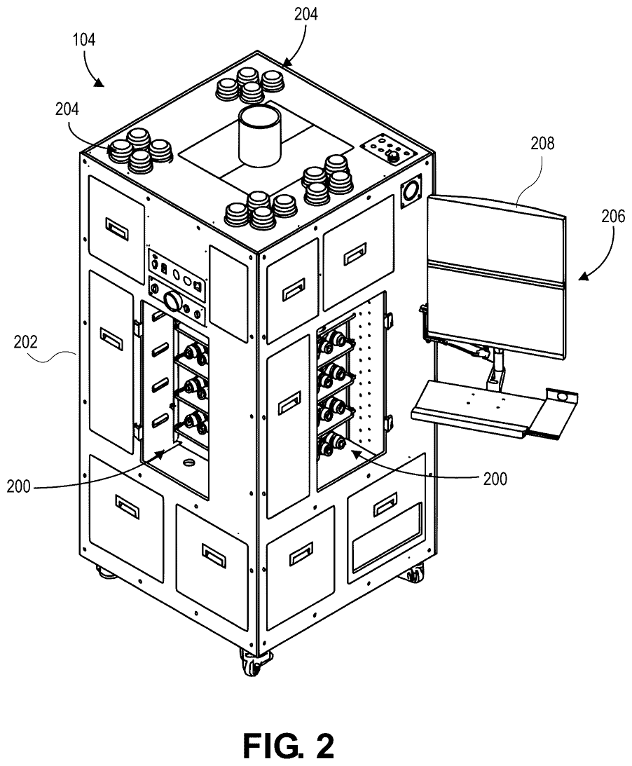

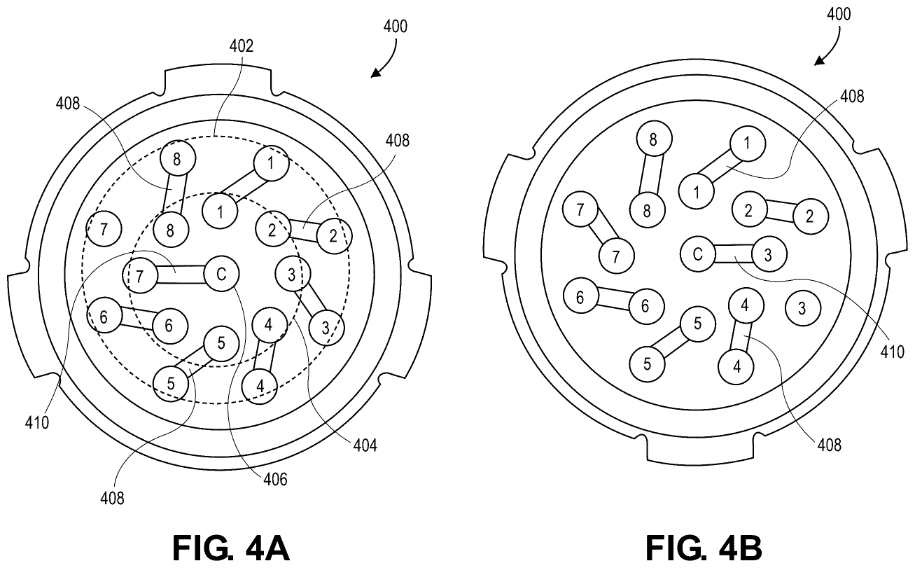

Referring to FIG. 2, an example of the distribution system 104 is shown with multiple valve cluster bays 200 supporting groups of valve clusters 116 within a case 202. The case 202 supports fluid conduits 204 to pass the fluid transfer lines 108, 110 to fluidically couple the valve clusters 116 with each of the remote sample devices 102 and the analysis systems 106. In implementations, the distribution system 104 includes three groups of valve clusters 116 within the same case 202, with each group of valve clusters 116 including sixteen valves to support distribution of samples having up to twelve different chemical compositions, maintained within specific valve clusters 116 to isolate samples having different chemical compositions, to up to twelve different analysis devices 106. Example valves and valve configurations for the valve clusters 116 are described further herein with respect to FIGS. 4A through 6B. The distribution system 104 is further shown including a user interface system 206 having displays 208 to provide and receive information associated with sample handling including, but not limited to, analyzer status of the analysis systems 106, sample identities (e.g., chemical compositions) of the samples at the remote sample devices 102, analyses to be performed on samples received from the remote sample devices 102, scheduling of sample analyses to be performed at each analysis system 106, rescheduling of sample analyses to be performed at each analysis system 106 to facilitate rapid processing of a priority or urgent sample, and the like.

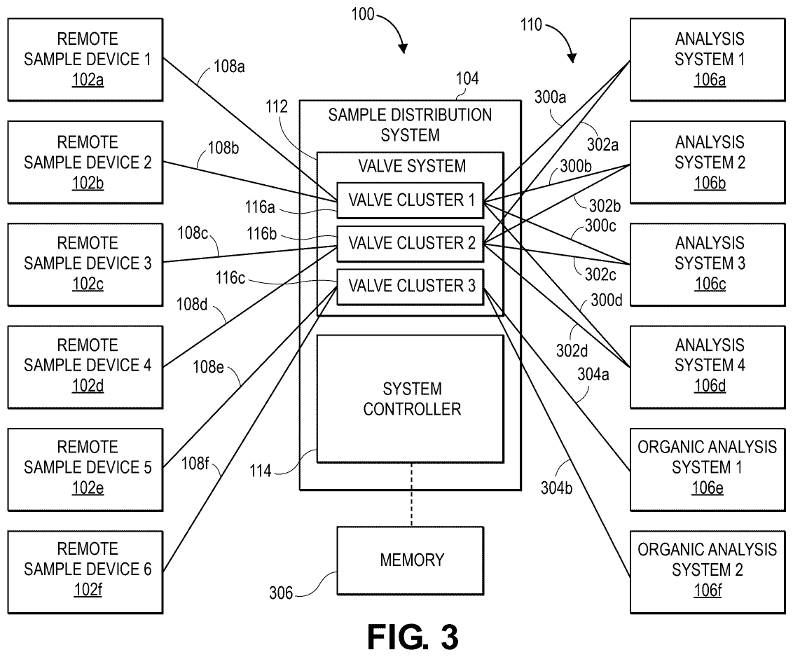

The system 100 facilitates the transfer of fluids through the distribution system 104 to prevent cross-contamination of different sample chemical compositions within the valve system 112 by including multiple valve clusters 116, where in implementations, each valve cluster 116 facilitates fluid transfer of a single chemical composition to multiple different analysis systems 106. For example, referring to FIG. 3, the system 100 is shown with the valve cluster 116a fluidically coupled with each of remote sample devices 102a, 102b via fluid transfer lines 108a, 108b, respectively, and fluidically coupled with each of analysis systems 106a, 106b, 106c, 106d via separate fluid transfer lines 110 (fluid transfer lines 300a, 300b, 300c, 300d are shown). The valve cluster 116b is fluidically coupled with each of remote sample devices 102c, 102d via fluid transfer lines 108c, 108d, respectively, and also fluidically coupled with each of analysis systems 106a, 106b, 106c, 106d via separate fluid transfer lines 110 (fluid transfer lines 302a, 302b, 302c, 302d are shown) distinct from the fluid transfer lines 110 used by the valve cluster 116a (i.e., fluid transfer lines 300a, 300b, 300c, 300d). The valve cluster 116c is fluidically coupled with each of remote sample devices 102e, 102f via fluid transfer lines 108e, 108f, respectively, and fluidically coupled with each of analysis systems 106e, 106f via separate fluid transfer lines 110 (fluid transfer lines 304a, 304b are shown). In this example, the samples from the remote sample devices 102a, 102b have the same chemical composition, the samples from the remote sample devices 102c, 102d have the same chemical composition as each other and can be different from the chemical composition of that of the samples from the remote sample devices 102a, 102b, and the samples from the remote sample devices 102e, 102f have the same chemical composition as each other and can be different from the chemical composition of that of the samples from the remote sample devices 102a, 102b, 102c, 102d. By maintaining separate fluid flow passageways through the valve system 112 for each valve cluster 116, the system 100 can prevent chemically dissimilar components from cross-contaminating to precipitate components, to dilute or react with components, or to otherwise jeopardize a chemical analysis by obfuscating the actual concentration of analytes within the original sample received from the remote sample devices 102. The system 100 is shown including a memory 306 accessible by the system controller 114 where the memory 306 can store information associated with operation of the system 100 including, but not limited to, a sample identity of each sample handled by the remote sample devices 102, an analysis procedure for each sample identity, and the like.

Referring to FIGS. 4A and 4B, a valve 400 of the valve clusters 116 is shown in accordance with an example implementation of the present disclosure. The valve 400 includes a plurality of fluid ports arranged as an outer ring 402, a plurality of fluid ports arranged as an inner ring 404, a central fluid port 406, a plurality of fluid channels 408 disposed between the outer ring 402 and the inner ring 402, and a central channel 410 disposed between the inner ring 404 and the central fluid port 406. For instance, the valve 400 is shown including eight fluid ports arranged as the outer ring 402, eight fluid ports arranged as the inner ring 404, and seven fluid channels disposed between the outer ring 402 and the inner ring 402, however the valve 400 is not limited to such configuration and can include more fluid ports or fewer fluid ports and a corresponding increase or decrease in the fluid channels 408 to facilitate handling of more or fewer fluid samples. The channels are rotatable relative to the ports to fluidically couple the central fluid port 406 with a single fluid port of the inner ring 404 while fluidically coupling the remainder of the fluid ports of the inner ring 404 with a corresponding fluid port of the outer ring 402. For example, the fluid channels 408 and the central channel 410 can be positioned on a rotor of the valve 400, with the fluid ports of the outer ring 402 and inner ring 404 positioned on a stator of the valve 400, where rotation of the rotor moves the fluid channels 408 and the central channel 410 between the fluid ports on the stator. However, the valve is not limited to such configuration and can include any combination of channels or ports on either of the rotor or the stator without departing from the scope of the present disclosure.

The valve 400 is shown in FIG. 4A in a first valve configuration that fluidically couples the central fluid port 406 with fluid port 7 of the inner ring 404 and to isolate fluid port 7 of the outer ring 402 from any fluid ports of the inner ring 404, whereas the remainder of the fluid ports of the inner ring 404 are fluidically coupled with the remainder of the fluid ports of the outer ring 402 via the fluid channels 408 (e.g., fluid ports 1-6 and 8 of the inner ring 404 are coupled with corresponding fluid ports 1-6 and 8 of the outer ring 402). In implementations, the fluid ports of the inner ring 404 are coupled with the fluid transfer lines 108 to receive samples from the remote sample devices 102 or to receive samples from another valve of a common valve cluster 116, the fluid ports of the outer ring 402 are coupled with fluid transfer lines to transfer sample to another valve of a common valve cluster 116 or to waste, and the central fluid port 406 is coupled with the fluid transfer lines 110 to transfer samples to respective analysis systems 106. The valve 400 is shown in FIG. 4B in a second valve configuration that fluidically couples the central fluid port 406 with fluid port 3 of the inner ring 404 and to isolate fluid port 3 of the outer ring 402 from any fluid ports of the inner ring 404, whereas the remainder of the fluid ports of the inner ring 404 are fluidically coupled with the remainder of the fluid ports of the outer ring 402 via the fluid channels 408 (e.g., fluid ports 1, 2, and 4-8 of the inner ring 404 are coupled with corresponding fluid ports 1, 2, and 4-8 of the outer ring 402). As such, the valve configuration of the valve 400 can direct which fluid port of the inner ring 404 is coupled to the central fluid port 406 for transfer to an analysis system 106, whereas the remainder of the fluid ports of the inner ring 404 is coupled with the fluid ports of the outer ring 402 to transfer fluids to additional valves 400, to waste, or to another location within the system 100, where the additional valves 400 can have their respective central fluid ports 406 fluidically coupled with different analysis systems 106.

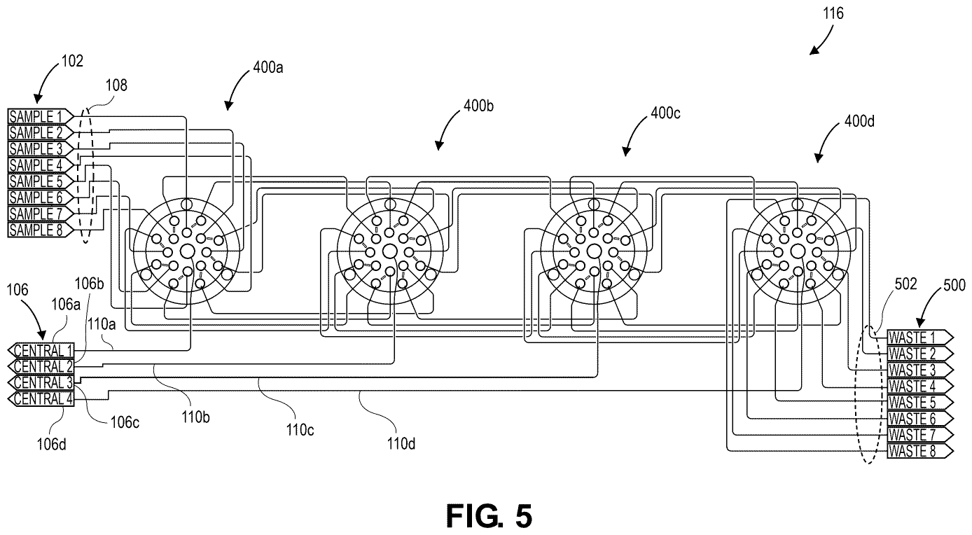

Referring to FIG. 5, an example valve cluster 116 is shown including four valves 400 (valves 400a, 400b, 400c, 400d are shown) to transfer samples received from any of up to eight remote sample devices 102 to any of up to four analysis systems 106. For instance, the fluid ports of the inner ring 404 of the valve 400a are coupled with the eight remote sample devices 102 via the fluid transfer lines 108 to receive the samples into the valve cluster 116. To transfer fluids between the valves 400a, 400b, 400c, 400d, the fluid ports of the outer ring 402 of the valve 400a are coupled with the fluid ports of the inner ring 404 of the valve 400b, the fluid ports of the outer ring 402 of the valve 400b are coupled with the fluid ports of the inner ring 404 of the valve 400c, and the fluid ports of the outer ring 402 of the valve 400c are coupled with the fluid ports of the inner ring 404 of the valve 400d. To transfer fluids from the valves 400a, 400b, 400c, 400d to the analysis devices 106, the central fluid port 406 of the valve 400a is coupled with the analysis system 106a via the fluid transfer line 110a, the central fluid port 406 of the valve 400b is coupled with the analysis system 106b via the fluid transfer line 110b, the central fluid port 406 of the valve 400c is coupled with the analysis system 106c via the fluid transfer line 110c, and the central fluid port 406 of the valve 400d is coupled with the analysis system 106d via the fluid transfer line 110d.

In implementations, the valve 400d facilitates the outlet of fluids to waste, such as for fluid samples awaiting transfer to the analysis systems 106 while other samples are directed thereto. For example, the valve 400d is shown with the fluid ports of the outer ring 402 fluidically coupled with waste outlets 500 (e.g., waste containers, drains, or the like) via fluid transfer lines 502.

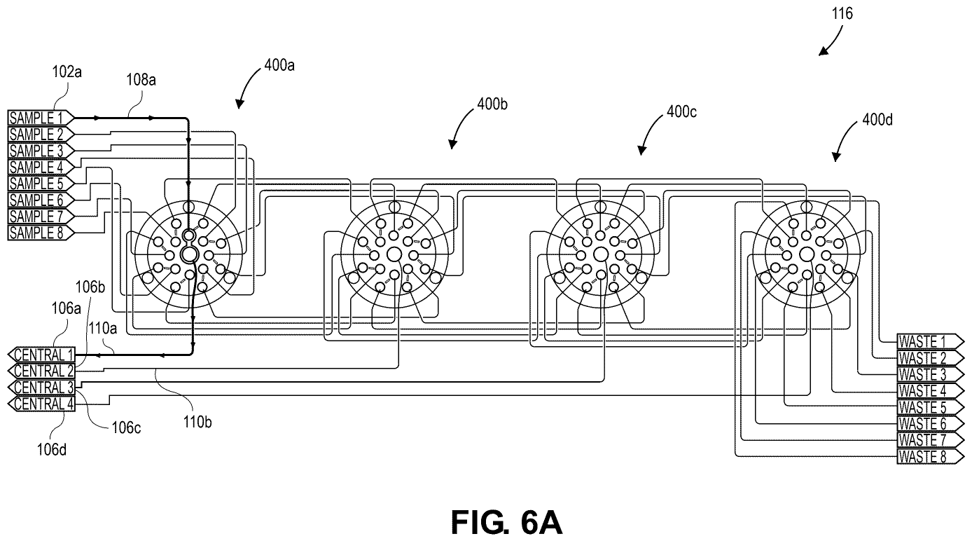

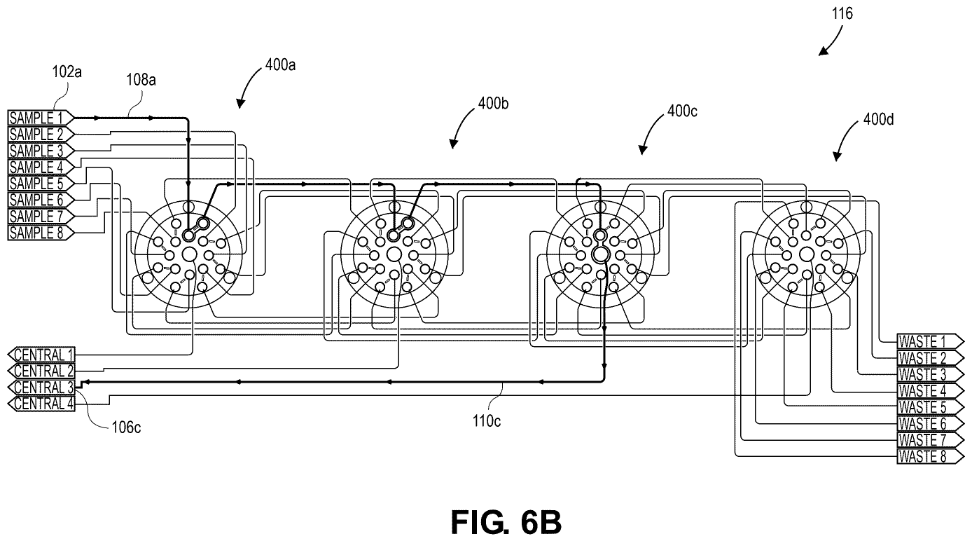

The system controller 114 can coordinate the valve configurations of each valve 400 of the valve cluster 116 to send a specific sample from a specific remote sample device 102 to a specific analysis system 106. For example, referring to FIGS. 6A and 6B, two different valve configurations of the valves 400a, 400b, 400c, 400d are shown to direct the same sample (e.g., the sample from remote sample device 102a) to two different analysis systems (e.g., analysis system 106a in FIG. 6A and analysis system 106c in FIG. 6B). For instance, referring to FIG. 6A, sample is received by the valve 400a from the remote sample device 102a via the fluid transfer line 108a. For example, the system 100 can transfer the sample from the remote sample device 102a through the fluid transfer line 108a and through the valve cluster 116 via pressurized gas transfer. The system controller 114 sets the valve 400a into a valve configuration that couples the fluid port that is coupled with the fluid transfer line 108a to the central fluid port 406 via the central channel 410 to direct the sample into the fluid transfer line 110a to the analysis system 106a. Samples received from any of the other remote sample devices 102 (e.g., samples 2-8 shown), such as through pressurized gas transfer, are directed from the valve 400a to the next valve 400b (e.g., by fluidically coupling the fluid ports of the outer ring 402 of the valve 400a with the fluid ports of the inner ring 404 of the valve 400b), where the system controller 114 can set the valve configuration to direct any of the remaining samples to the analysis system 106b via the fluid transfer line 110b. For example, the system controller 114 can set the valve configuration of the valve 400a to couple the central fluid port 406 with the desired incoming sample port via the central channel 410 to direct the sample into the fluid transfer line 110b to the analysis system 106b. Similarly, the system controller 114 can set any of the remaining valves 400c, 400d to direct any of the remaining samples not sent to the analysis systems 106a, 106b to the analysis systems 106c, 106d. Alternatively or additionally, the system controller 114 can set any of valves 400b, 400c, 400d to direct the sample received from the remote sample device 102a to any of the analysis systems 106b, 106c, 106d. For instance, the system 100 can analyze a single sample with multiple analysis systems 106 to verify an analytical result of any other of the analysis systems 106, such as when a contaminate is identified in the sample (e.g., the presence of a chemical analyte that exceeds a predetermined contaminate threshold).

Referring to FIG. 6B, sample is received by the valve 400a from the remote sample device 102a via the fluid transfer line 108a. The system controller 114 sets the valve 400a into a valve configuration that couples the fluid port that is coupled with the fluid transfer line 108a to the corresponding fluid port in the outer ring 402 via one of the fluid channels 408 to direct the sample to the valve 400b (e.g., received into a fluid port of the inner ring 404 of valve 400b). The system controller 114 sets the valve 400b in the same configuration as valve 400a (or in another configuration to direct a different sample to the central fluid port for transfer to the analysis system 106b) to transfer the sample from remote sample device 102a to the valve 400c (e.g., received into a fluid port of the inner ring 404 of valve 400c). The system controller 114 sets the valve 400c into the same configuration as valve 400a in FIG. 6A to direct the sample through the central channel 410 and into the fluid transfer line 110c for passage to the analysis system 106c. The system controller 114 can set any of the other valves 400a, 400b, 400d to direct any of the remaining samples (e.g., samples 2-8 shown) to any of the analysis systems 106a, 106b, 106d.

The number of valves 400 in a single valve cluster 116 generally depends on the number of remote sample devices 102 that are fluidically coupled with the valve cluster 116 and the number of analysis systems 106 that are fluidically coupled with the valve cluster 116 to receive the samples for analysis. In implementations, a single valve cluster 116 includes as a minimum number of valves the same number of valves 400 as the number of analysis systems 106 for receiving samples from the remote sample devices 102 that are fluidically coupled with the valve cluster 116. For example, in the embodiment of the system 100 shown in FIG. 3, the minimum number of valves 400 for valve clusters 116a and 116b can be four, since each of the valve clusters 116a, 116b is configured to direct sample from any of two remote sample devices 102 to any of four analysis systems 106 (e.g., analysis systems 106a, 106b, 106c, 106d), whereas the minimum number of valves 400 for valve cluster 116c can be two, since the valve cluster 116c is configured to direct sample from any of two remote sample devices 102 to any of two analysis systems 106 (e.g., analysis systems 106e, 106f).

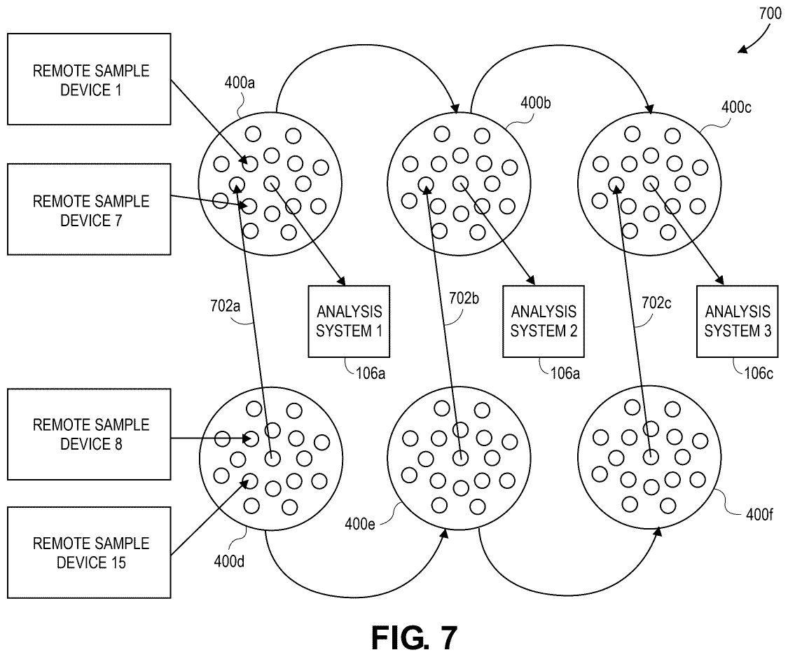

Such minimum number of valves 400 in a valve cluster 116 can also depend on the number of samples received into the valve cluster 116 from unique remote sample devices 102. For example, if the system 100 utilizes a valve cluster 116 to receive samples from more than eight unique remote sample devices 102 (e.g., for valves 400 having eight fluid ports in each of the inner ring 404 and outer ring 402), the minimum number of valves 400 can double to accommodate the increase in potential samples received. As would be appreciated by one of skill in the art, increasing the number of ports in the valves 400 would increase the number of unique remote sample devices 102 that a valve cluster 116 can process. For instance, referring to FIG. 7, a valve cluster 700 is shown including six valves 400 (e.g., valves 400a, 400b, 400c, 400d, 400e, 400f) configured to direct sample received from any of fifteen remote sample devices 102 to any of three analysis systems 106. The valve 400a can directly receive sample from any of seven unique remote sample devices 102 and can indirectly receive sample from any of an additional eight unique remote sample devices 102 via the valve 400d. For example, the valve 400d can be fluidically coupled with the valve 400a via a fluid transfer line 702a that fluidically couples the central fluid port 406 of the valve 400d with a fluid port on the inner ring 404 of the valve 400a. Similarly, the valve 400e is fluidically coupled to the valve 400b via a fluid transfer line 702b and the valve 400f is fluidically coupled to the valve 400c via a fluid transfer line 702c to direct any of the remaining fluids received by valve 400d to either of valves 400e and 400f and subsequently to valves 400b or 400c to direct any of the samples received from fifteen unique remote sample devices 102 to any of the three analysis systems 106. The valve cluster 700 can be expanded to accommodate additional analysis systems 106, such as by adding a pair of valves 400 for each additional analysis system 106 to transfer any of the samples received from fifteen unique remote sample devices 102 to any of the analysis systems 106.

In implementations, in order to maintain separation of types of samples within the distribution system 104 by including separate valve clusters 116 for each unique sample chemical composition, the total number of valves 400 present at the distribution system 104 can be determined according to equation (1):

$$Number of Valves = 3 ( C * m ) + 2 ( C * n ) + [ C * ( N - n - m ) ] \qquad ( 1 )$$

where C is the number of analysis systems 106, N is the number of unique types of chemical compositions (e.g., hydrofluoric acid (HF) is one type, ammonium hydroxide (NH4OH) is a second type, isopropyl alcohol (IPA) is a third type, etc.), n is the number of chemicals with more than eight sample sources originating from the remote sample devices 102, and m is the number of chemicals with more than fifteen sample sources originating from the remote sample devices 102.

For a valve arrangement of the distribution system 104 without maintaining separation of the valve groupings for each sample type, the number of valves present at the distribution system 104 can be determined according to equation (2):

$$Number of Valves = C * V \qquad ( 2 )$$

where C is the number of analysis systems 106 and V is (X−1)/7, where X is the total number of sample sources originating from the remote sample devices 102, and where V is rounded up to the nearest integer valve.

As an example, for a system having four analysis systems 106 to analyze five samples of hydrofluoric acid, ten samples of sulfuric acid, five samples of an acid mixture, seventeen samples of hydrogen peroxide, fourteen samples of ammonium hydroxide, eight samples of isopropyl alcohol, and four samples of a photoresist solvent, the number of valves 400 utilized in the distribution system 104 while maintaining separate valve groupings for each of the seven sample types would be, according to equation (1), 3(4*1)+2(4*2)+[4*(7−2−1)]=12+16+16=44 valves. The number of valves utilized in the distribution for the samples, but without maintaining separation of the valve groupings for each sample type would be determined with a value of V being (63−1)/7, which is approximately 8.875, which would be rounded up to 9, so the total number of valves would be 4*9=36 valves.

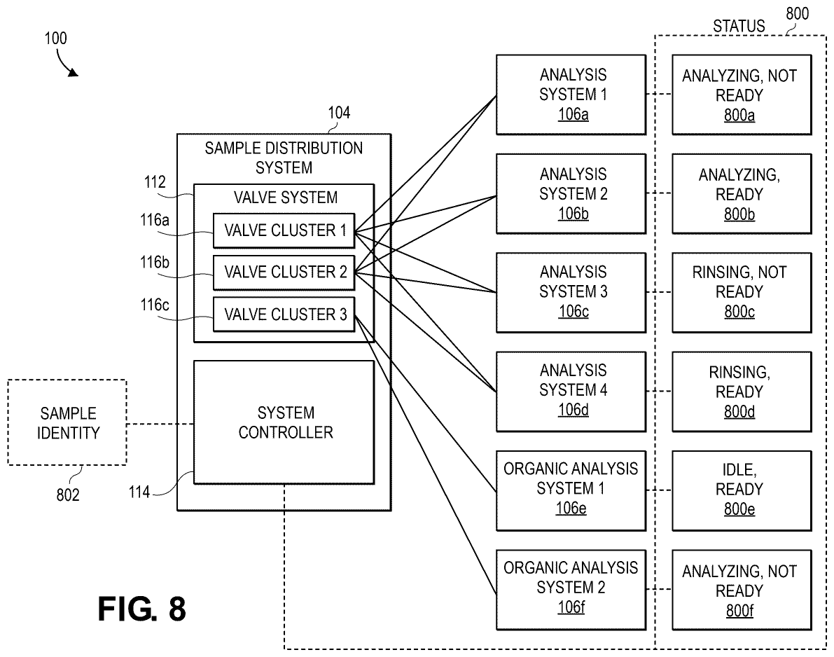

In implementations, the system 100 facilitates coordination of directing samples to analysis systems based upon an analysis status of the individual analysis devices. For instance, the system 100 can track the availability of individual analysis devices based on factors including, but not limited to, expected time to process and analyze a sample, time between samples to rinse, type of analysis device, maintenance schedule or operation for the analysis device, and the like. For example, referring to FIG. 8, the system 100 is shown with the system controller 114 receiving an analysis system status 800 from each analysis system 106 (e.g., analysis systems 106a, 106b, 106c, 106d, 106e, 106f shown with corresponding statuses 800a, 800b, 800c, 800d, 800e, 800f). For a sample to be processed that flows through the valve cluster 116a (e.g., one or more samples from remote sample devices 102a, 102b from FIG. 3), the system controller 114 can acknowledge that while any of analysis systems 106a, 106b, 106c, 106d are potential analysis systems 106 to handle the samples through the valve cluster 116a, analysis systems 106a and 106c are not valid destinations at the given point in time due to the corresponding statuses 800a, 800c of “analyzing, not ready” and “rinsing, not ready,” whereas analysis systems 106b and 106d are valid destinations at the given point in time due to the corresponding statuses 800b, 800d of “analyzing, ready” and “rinsing, ready.” The system controller 114 can therefore assign the valve configurations of the valves 400 of the valve cluster 116a to direct the sample to one or more of analysis systems 106b and 106d. The system controller 114 can process samples received by the valve cluster 116b in a similar manner. For a sample to be processed that flows through the valve cluster 116c (e.g., one or more samples from remote sample devices 102e, 102f from FIG. 3), the system controller 114 can acknowledge that while either of analysis systems 106e, 106f are potential analysis systems 106 to handle the samples through the valve cluster 116c, analysis systems 106f is not a valid destination at the given point in time due to the corresponding status 800f of “analyzing, not ready,” whereas analysis system 106e is a valid destination at the given point in time due to the corresponding status 800e of “idle, ready.” The system controller 114 can therefore assign the valve configurations of the valves 400 of the valve cluster 116c to direct the sample to analysis system 106e.

The status can be programmed to provide a variety of considerations for whether the analysis device 106 is ready or not ready for a particular sample. In implementations, whether an analysis device 106 is ready or not ready for a particular sample is related to the sample identity of a sample currently under analysis by that analysis system 106 or the last sample analyzed by that analysis system 106. For instance, the system controller 112 can access a sample identity 802 of each sample received from the remote sample devices 102 (e.g., via retrieval from a system memory, such as memory 306, via communication with other components of the system 100, etc.). For instance, if the next sample to be analyzed is of the same sample chemical composition as the sample currently under analysis by that analysis system 106 or the last sample analyzed by that analysis system 106 (e.g., the next sample is handled by the same valve cluster 116 as the prior sample), then the status can include a “ready” component during analysis or rinsing of a current sample or completion thereof, since the risk of cross-contamination is low. If the next sample to be analyzed is of a different sample chemical composition as the sample currently under analysis by that analysis system 106 or the last sample analyzed by that analysis system 106 (e.g., the next sample is handled by a different valve cluster 116 than the prior sample), then the status can include a “not ready” component during analysis of a current sample or completion thereof, since the risk of cross-contamination is higher than if the next sample were to be handled by the same valve cluster 116. Further, the analysis device having the status 800 with the “not ready” component could include components (e.g., spray chamber, injector type, plasma torch type, etc.) that are unsuitable or otherwise not optimized to handle the sample type of the next sample. For example, even though the valve cluster 116b is fluidically coupled with the same analysis systems 106 are the valve cluster 116a (e.g., analysis systems 106, 106b, 106c, 106d), the status 800 of each analysis system 106 could change based on the identity of the next sample to be handled since the sample type of the sample handled by the valve cluster 116b could be different than the sample type of the sample handled by the valve cluster 116a.

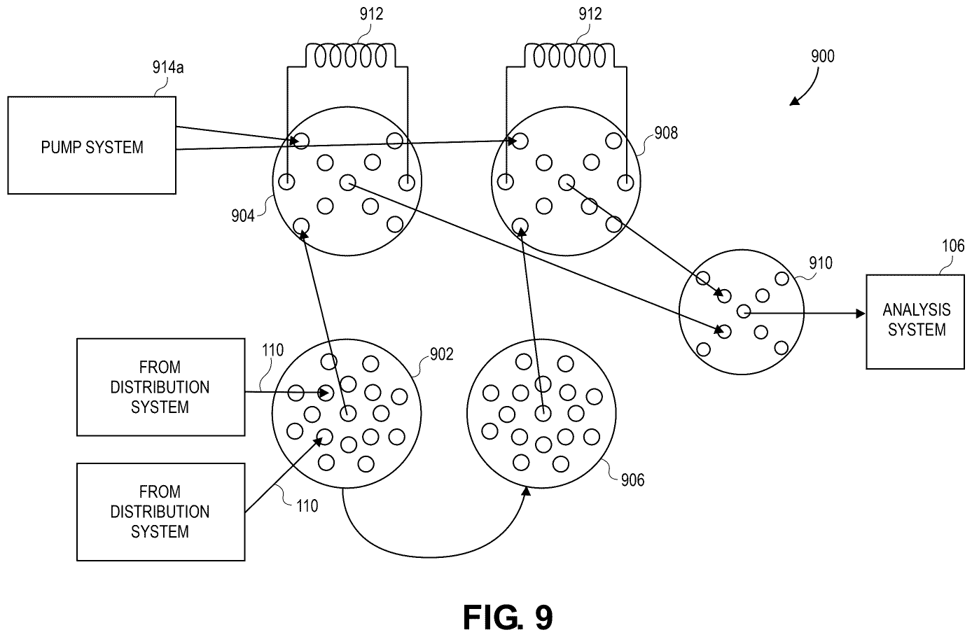

The system 100 can facilitate holding one or more samples at an analysis system to efficiently queue samples received from the distribution system 104 for analysis by the specific analysis system. For example, referring to FIG. 9, the system 100 is shown with an analysis system 106 including a sample hold system 900 configured to receive samples from the distribution system 104 via the fluid transfer lines 110 (e.g., shown with up to eight transfer lines from the distribution system 104 received by a valve 902, such as one structured as the valve 400). The valve 902 is fluidically coupled with each of a holding valve 904 and a transfer valve 906 to transfer any one of the samples received to the holding valve 904 (e.g., via a central port 406) and transfer any of the remaining samples to the transfer valve 906, which in turn is fluidically coupled with a second holding valve 908. Each of the holding valve 904 and the second hold valve 908 is fluidically with an analysis valve 910 and includes a sample loop 912 having a known volume to hold the known volume of sample therein for subsequent transfer to the analysis valve 910 which in turn is fluidically coupled with the analysis system 106. The sample hold system 900 further includes a pump system 914 to push the samples held in the sample loops 912 of the respective holding valves to the analysis valve 910 for analysis of the samples. For example, the system controller 114 can coordinate which sample is transferred to the analysis valve 910 or from the analysis valve to the analysis system 106 for analytical determination of analyte concentration in the fluid sample. Alternatively or additionally, the system 100 can facilitate sample preparation of a sample at the analysis system 106, such as through adding one or more diluents, standards, reagents, or the like at one or both of the holding valves 904, 908 prior to transferring the sample to the analysis valve 910.

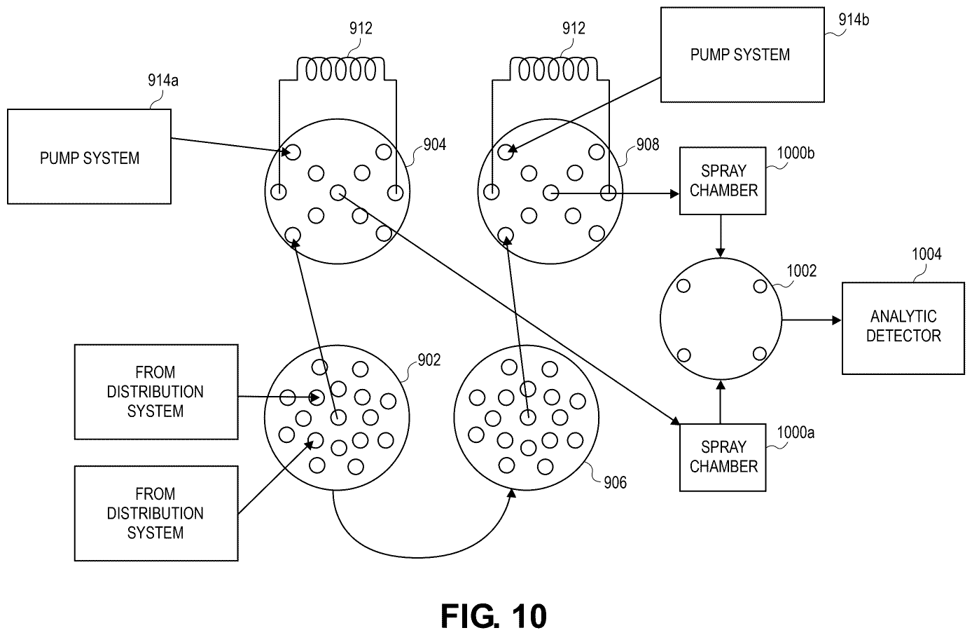

In implementations, the system 100 can utilize an analysis system having multiple spray chambers to facilitate serial processing of samples while alternating sample transfer through the spray chambers, such as to rinse and condition one spray chamber while the other spray chamber processes sample. For example, referring to FIG. 10, the system 100 is shown with an analysis system 106 including the sample hold system 900 described with respect to FIG. 9, however instead of sending samples from the holding loops 912 to the analysis valve 910, each holding valve 904, 908 is fluidically coupled with a separate spray chamber 1000 (spray chambers 1000a, 1000b shown). The pump system 914 (e.g., pump systems 914a, 914b are shown) pushes the respective samples to the respective spray chambers, such as under control by the system controller 114. The spray chambers 1000 are fluidically coupled with a selection valve 1002 that provides a flow path configuration for one of the spray chambers 1000 to be fluidically coupled with the analytic detector 1004 of the analysis system 106 and for the other one of the spray chambers 1000 to be fluidically coupled with a waste outlet. For example, the selection valve 1002 can include an aerosol valve configured to alternately permit transfer of sample from the spray chambers to the analytic detector 1004 (e.g., ICPMS detector).

The system 100 can include a data repository (e.g., within the distribution system 104, within a cloud server, or combinations thereof) to collect analytic data from each of the analysis systems 106 for a user to review sample data. In implementations, the sample data is tagged as being sourced from a specific analysis device 106, which can provide insight into whether a sample should be analyzed by a different analysis device 106 or whether a potential contamination was identified that should be verified by a new analysis.

Electromechanical devices (e.g., electrical motors, servos, actuators, or the like) may be coupled with or embedded within the components of the system 100 to facilitate automated operation via control logic embedded within or externally driving the system 100. The electromechanical devices can be configured to cause movement of devices and fluids according to various procedures, such as the procedures described herein. The system 100 may include or be controlled by a computing system having a processor or other controller configured to execute computer readable program instructions (i.e., the control logic) from a non-transitory carrier medium (e.g., storage medium such as a flash drive, hard disk drive, solid-state disk drive, SD card, optical disk, or the like). The computing system can be connected to various components of the system 100, either by direct connection, or through one or more network connections (e.g., local area networking (LAN), wireless area networking (WAN or WLAN), one or more hub connections (e.g., USB hubs), and so forth). For example, the computing system can be communicatively coupled to a system controller, ICP torch, carriage motors, fluid handling systems (e.g., valves, pumps, etc.), other components described herein, components directing control thereof, or combinations thereof. The program instructions, when executed by the processor or other controller, can cause the computing system to control the system 100 according to one or more modes of operation, as described herein.

It should be recognized that the various functions, control operations, processing blocks, or steps described throughout the present disclosure may be carried out by any combination of hardware, software, or firmware. In some embodiments, various steps or functions are carried out by one or more of the following: electronic circuitry, logic gates, multiplexers, a programmable logic device, an application-specific integrated circuit (ASIC), a controller/microcontroller, or a computing system. A computing system may include, but is not limited to, a personal computing system, a mobile computing device, mainframe computing system, workstation, image computer, parallel processor, or any other device known in the art. In general, the term “computing system” is broadly defined to encompass any device having one or more processors or other controllers, which execute instructions from a carrier medium.

Program instructions implementing functions, control operations, processing blocks, or steps, such as those manifested by embodiments described herein, may be transmitted over or stored on carrier medium. The carrier medium may be a transmission medium, such as, but not limited to, a wire, cable, or wireless transmission link. The carrier medium may also include a non-transitory signal bearing medium or storage medium such as, but not limited to, a read-only memory, a random access memory, a magnetic or optical disk, a solid-state or flash memory device, or a magnetic tape.

### CONCLUSION

It will be appreciated that features described herein with respect to embodiments or implementations can be combined with any other feature or features described with respect to the same or alternative embodiments, unless context otherwise dictates, without departing from the scope of the present disclosure.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

1. A system for collecting, transferring, and distributing fluid samples taken from multiple remote sample devices to multiple analysis systems via an intervening sample distribution system while maintaining sample separation within the sample distribution system on the basis of chemical composition, comprising:
a plurality of remote sample devices, each remote sample device configured to draw a fluid sample from a sample source;
a plurality of analysis systems configured to determine a chemical composition of the fluid sample from each remote sample device;
a distribution system fluidically coupled with each remote sample device of the plurality of remote sample devices via a dedicated fluid transfer line for each remote sample device of the plurality of remote sample devices and with each analysis system of the plurality of analysis systems via at least one fluid transfer line, the distribution system including a valve system having a plurality of valve clusters changeable between different valve configurations to direct fluid from the plurality of remote sample devices to the plurality of analysis systems, wherein each valve cluster of the plurality of valve clusters is configured to transfer samples having a unique chemical composition, and wherein at least two valve clusters of the plurality of valve clusters are fluidically coupled with the same analysis system of the plurality of analysis systems; and
a system controller configured to assign the valve configurations of each valve of a valve cluster to transfer sample through the valve cluster to a specific analysis system.

2. The system of claim 1, wherein the valve system includes a first valve cluster and a second valve cluster, wherein the first valve cluster is configured to transfer chemical samples of a first sample type while excluding passage of chemical samples of a second sample type, and wherein the second valve cluster is configured to transfer chemical samples of the second sample type while excluding passage of chemical samples of the first sample type.

3. The system of claim 2, wherein each of the first valve cluster and the second valve cluster is fluidically coupled with the same analysis system of the plurality of analysis systems.

4. The system of claim 3, wherein at least one of the first valve cluster and the second valve cluster is fluidically coupled with more than one analysis system of the plurality of analysis systems.

5. The system of claim 2, wherein neither of the first valve cluster and the second valve cluster is fluidically coupled with the same analysis system of the plurality of analysis systems.

6. The system of claim 5, wherein at least one of the first valve cluster and the second valve cluster is fluidically coupled with more than one analysis system of the plurality of analysis systems.

7. The system of claim 1, wherein the system controller is configured to assign the valve configurations of each valve of a given valve cluster to transfer sample through the valve cluster to a specific analysis system based at least on a status of the specific analysis system communicated from the specific analysis system to the system controller.

8. The system of claim 7, wherein the status of the specific analysis system is dependent on a sample most recently processed by the specific analysis system as compared to a next sample from the plurality of remote sample devices available to transfer through the distribution system.

9. The system of claim 1, wherein a valve cluster of the plurality of valve clusters includes a first valve and a second valve fluidically coupled with the first valve, wherein the first valve is fluidically coupled with at least a subset of the plurality of remote sample devices to receive a plurality of fluid samples, the first valve including a port fluidically coupled with a first analysis system of the plurality of analysis systems and defining a first valve configuration to transfer one sample of the plurality of fluid samples to the first analysis system and to direct the remaining samples of the plurality of fluid samples to the second valve.

10. The system of claim 9, wherein the second valve includes a port fluidically coupled with a second analysis system of the plurality of analysis systems and defining a second valve configuration to transfer one sample of the remaining samples of the plurality of fluid samples to the second analysis system and to transfer any other remaining samples.

11. The system of claim 10, wherein the valve cluster further includes a third valve fluidically coupled with the second valve and including a port fluidically coupled with a third analysis system of the plurality of analysis systems, the third valve cluster defining a third valve configuration to receive the any other remaining samples from the second valve and to direct one of the any other remaining samples to the third analysis system.

12. The system of claim 1, wherein the distribution system further comprises a case configured to support each valve cluster of the plurality of valve clusters.

13. A system for collecting, transferring, and distributing fluid samples taken from multiple remote sample devices to multiple analysis systems via an intervening sample distribution system while maintaining sample separation within the sample distribution system on the basis of chemical composition, comprising:
a plurality of remote sample devices, each remote sample device configured to draw a fluid sample from a sample source;
a plurality of analysis systems configured to determine a chemical composition of the fluid sample from each remote sample device;
a distribution system fluidically coupled with each remote sample device of the plurality of remote sample devices via a dedicated fluid transfer line for each remote sample device of the plurality of remote sample devices and with each analysis system of the plurality of analysis systems via at least one fluid transfer line, the distribution system including a valve system having a plurality of valve clusters changeable between different valve configurations to direct fluid from the plurality of remote sample devices to the plurality of analysis systems, wherein each valve cluster of the plurality of valve clusters is configured to transfer samples having a unique chemical composition, wherein the valve system includes a first valve cluster and a second valve cluster, wherein the first valve cluster is configured to transfer chemical samples of a first sample type while excluding passage of chemical samples of a second sample type, wherein the second valve cluster is configured to transfer chemical samples of the second sample type while excluding passage of chemical samples of the first sample type, wherein at least two valve clusters of the plurality of valve clusters are fluidically coupled with the same analysis system of the plurality of analysis systems, and wherein the distribution system further comprises a case configured to support each valve cluster of the plurality of valve clusters; and
a system controller configured to assign the valve configurations of each valve of a valve cluster to transfer sample through the valve cluster to a specific analysis system.

14. The system of claim 13, wherein each of the first valve cluster and the second valve cluster is fluidically coupled with the same analysis system of the plurality of analysis systems.

15. The system of claim 14, wherein at least one of the first valve cluster and the second valve cluster is fluidically coupled with more than one analysis system of the plurality of analysis systems.

16. The system of claim 13, wherein neither of the first valve cluster and the second valve cluster is fluidically coupled with the same analysis system of the plurality of analysis systems.

17. The system of claim 16, wherein at least one of the first valve cluster and the second valve cluster is fluidically coupled with more than one analysis system of the plurality of analysis systems.

18. The system of claim 13, wherein the system controller is configured to assign the valve configurations of each valve of a given valve cluster to transfer sample through the valve cluster to a specific analysis system based at least on a status of the specific analysis system communicated from the specific analysis system to the system controller.

19. The system of claim 18, wherein the status of the specific analysis system is dependent on a sample most recently processed by the specific analysis system as compared to a next sample from the plurality of remote sample devices available to transfer through the distribution system.

20. The system of claim 13, wherein a valve cluster of the plurality of valve clusters includes a first valve and a second valve fluidically coupled with the first valve, wherein the first valve is fluidically coupled with at least a subset of the plurality of remote sample devices to receive a plurality of fluid samples, the first valve including a port fluidically coupled with a first analysis system of the plurality of analysis systems and defining a first valve configuration to transfer one sample of the plurality of fluid samples to the first analysis system and to direct the remaining samples of the plurality of fluid samples to the second valve, and wherein the second valve includes a port fluidically coupled with a second analysis system of the plurality of analysis systems and defining a second valve configuration to transfer one sample of the remaining samples of the plurality of fluid samples to the second analysis system and to transfer any other remaining samples.
